(19) United States
(12) Patent Application Publication
(10) Pub. No.: US 2006/0250983 A1
(43) Pub. Date: Nov. 9, 2006

(54) Method of and arrangement for establishing network connections in an ethernet environment

(75) Inventor: Nrin Tan Thuan Hui, Penang (MY)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: IRIS CORPORATION BERHAD

(21) Appl. No.: 11/357,326

(22) Filed: Feb. 17, 2006

(30) Foreign Application Priority Data
Mar. 31, 2005 (MY) PI20051445

(51) Int. Cl. H04L 12/28

(52) U.S. Cl. 370/254

(57) ABSTRACT

Method of and arrangement for establishing network connections in an Ethernet environment in which the connection topology for CAT5/5e/6 is changed from a star topology to a bus looping connection topology to ease the structured cabling setup and reduce cable cost. It also provides link redundancy by means of loopback in the event of a cable broken failure. Power supply unit supply power to a plurality of junction boxes in a bus looping connection.

### BACKGROUND ART

The invention relates to a method of and arrangement for establishing network connections in an Ethernet environment in which the connection topology for CAT5/5e/6 is changed from a star topology to a bus looping connection topology in a structured cabling system. An Ethernet switch has a plurality of ports with each port connected to a network terminal, device, clients and or servers. In a large star topology environment the structured cabling cost and complexity of will increase whereby every single network terminal, device, clients and or server connection point must be connect to the Ethernet switch.

A computer network with a star network topology, in its simplest form, consists of one central, or hub computer which acts as a router to transmit messages between connected computers by a store-and-forward or switching system. A hierarchical extension of the star topology allows each node connected by a hub to in turn play the role of a hub for a disjoint set of leaf notes. In this case multiple routes may exist between any two given nodes of the network. Advantages easy to implement and extend, even in large networks. Its well suited for temporary networks (quick setup), typically the cheapest topology to implement. Failure of one station does not affect others. Easy to administer/troubleshoot, any cable break doesn't disable the entire network, simplified key management in some encryption schemes. The disadvantages, limited cable length and number of stations, maintenance costs may be higher in the long run, performance degrades as additional computers are added, failure of the central node can disable the entire network. The invention of this method of and arrangement for establishing network connections in an Ethernet environment such problem can be overcome.

BNC connector (Bayonet Nut Coupling) A commonly used plug and terminal for audio, video and network applications that provides a tighter connection. Using a mount somewhat similar to the way a bayonet (knife) is mounted onto the end of a rifle, BNCs are used to connect a variety of different coaxial cable types. After the plug is inserted, it is turned, causing pins in the terminal to be pinched into a locking groove on the plug.

There are numerous definitions of the BNC acronym, including Bayonet Neill-Concelman (after its inventors), Barrel Nut Connector, Bayonet Nipple Connector, Bayonet Navy Connector, Baby N Connector, British Naval Connector and British National Connector. BNC T-connector is usually used to connect each node of your network points to the end of thin net coaxial cable attached to the Ethernet devices, the major disadvantage in using thin net cabling is that if there is a fault in the cabling at any computer, it affects all computers on the network. The system can be brought down by one fault in hardware, with a new method of and arrangement for establishing network connections in an Ethernet environment such problem can be eliminated.

A hub is a computer networking device that connects multiple Ethernet segments together making them act as a single segment. When using a hub, every attached device shares the same broadcast domain and the same collision domain. Therefore, only one computer connected to the hub is able to transmit at a time. In general, a hub is a central node in a network. The term comes from the analogy to a wheel's hub, which is the center of the wheel with spokes radiating out from it. Depending on the network topology, the hub provides a basic level 1 OSI model connection among the network objects (workstations, servers, etc). It provides bandwidth which is shared among all the objects, compared to switches, which provide a dedicated connection between individual nodes. A network device that crosses connects stations of LAN segments. Also known as a “frame switch,” LAN switches are available for Ethernet, Fast Ethernet, Token Ring and FDDI. ATM switches are generally considered in a category by themselves. Network switches are increasingly replacing shared media hubs in order to increase bandwidth. For example, a 16-port 100 BaseT hub shares the total 100 Mbps bandwidth with all 16 attached nodes. By replacing the hub with a switch, each sender/receiver pair has the full 100 Mbps capacity. Each port on the switch can give full bandwidth to a single server or client station or it can be connected to a hub with several stations. The disadvantage for both hub and switch is the limitation of number of port can be connected to single hub/switch, therefore if more then 100 or 1000 ports are require usually many hubs and switches has to be used to connect all individual nodes, which means the cost for hardware and cabling to loop each nodes to these hubs or switches is become very expensive, with a new method of and arrangement for establishing network connections in an Ethernet environment help to reduce number of hub and switch require for the environment that require more then 100 or 1000 nodes connection.

A bus network is a network architecture in which a set of clients are connected via a shared communications line, called a bus. There are several common instances of the bus architecture, including one in the motherboard of most computers, and those in some versions of Ethernet networks. Bus networks are the simplest way to connect multiple clients, but often have problems when two clients want to communicate at the same time on the same bus. Thus systems which use bus network architectures normally have some scheme of collision handling or collision avoidance for communication on the bus, quite often using Carrier Sense Multiple Access. The bus topology is passive—the computers on the bus simply listen for a signal; they are not responsible for moving the signal along. The disadvantages of Bus network is difficult to administer/troubleshoot, limited cable length and number of stations, a cable break can disable the entire network, maintenance costs may be higher in the long run, performance degrades as additional computers are added. All these disadvantages can be improve by implementing the invented method of and arrangement for establishing network connections in an Ethernet environment in which the connection topology for CAT5/6 is changed from a star topology to a bus looping connection topology to ease the structured cabling setup and can reduce the cable cost in total.

The new method of and arrangement for establishing network connections in an Ethernet environment overcome the maximum cable length limitation and able to maintain or enhance the base band transmission rate at 10 megabits up to 1000 megabits (10 to 1000 million of Giga bits) per second at half duplex, full duplex collision, transmit activity and receive activity.

### SUMMARY OF THE INVENTION

It is an objective of the invention to provide method of and arrangement for establishing network connections in an Ethernet environment in which the connection topology for CAT5/5e/6 is changed from a star topology to a bus looping connection topology to ease the structured cabling setup and reduce cable cost.

It is another objective of the invention to provide link redundancy by means of loop back whereby the last port in the bus looping connection topology is connected back to the loop back input port of the main switch thereby forming an alternative path in the event of a cable broken failure in the structured cabling.

It is another objective of the invention to provide additional bandwidth by means of combining multiple ports to function as one whereby the total bandwidth doubles with every addition port and traffic is aggregated among the combined ports in a bus looping connection topology thereby providing increased bandwidth and redundancy in the structured cabling.

It is another objective of the invention to provide a power supply extension unit to supply power to one and or more junction boxes in a bus looping connection topology in a structured cabling system.

The invention will now be further described by way of example with reference to the accompanying drawings.

### DESCRIPTION OF THE DRAWINGS

FIG. 1 illustrates a general form of bus looping connection topology in accordance with the invention.

FIG. 2 illustrates alternative form of bus looping with link aggregation connection topology in accordance with the invention.

FIG. 3 illustrates alternative form of bus looping with loop back connection topology in accordance with the invention.

FIG. 4 illustrates a general form of power supply extension unit in accordance with the invention.

FIG. 5 illustrates alternative form of power supply extension unit in accordance with the invention.

FIG. 6 illustrates a general form of power supply extension unit with link aggregation in accordance with the invention.

FIG. 7 illustrates alternative form of power supply extension unit with link aggregation in accordance with the invention.

FIG. 8 illustrates a general form of junction box in accordance with the invention.

FIG. 9 illustrates alternative form of junction box in accordance with the invention.

FIG. 10 illustrates a general form of junction box with link aggregation in accordance with the invention.

FIG. 11 illustrates alternative form of junction box with link aggregation in accordance with the invention.

### DETAILED DESCRIPTION OF THE PREFERRED EMBODIMENT

Referring to FIG. 1, there is illustrated therein a general form of bus looping connection topology in accordance with this invention, the bus loop comprising an RJ45 CAT5/5e/6 twisted pair cable 20, connecting to a power supply extension unit 10, supplying power to a chain ofjunction boxes 11 using the said RJ45 CAT5/5e/6 twisted pair cables 20, repeated again and again using the said power supply extension units 10 and chains of junction boxes 11. Network terminals, devices, clients and or servers 14 are connected to the said power supply extension units 10 and junction boxes 11 using the said RJ45 CAT5/5e/6 twisted pair cables 21.

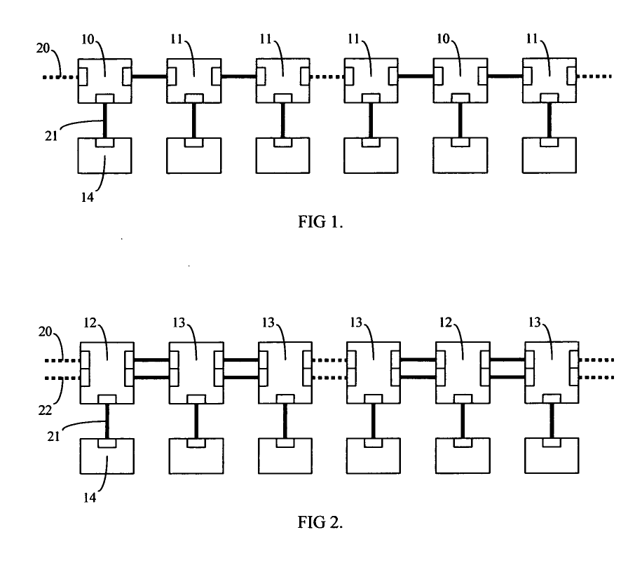

Referring to FIG. 2, there is illustrated therein an alternative form of bus looping with link aggregation connection topology in accordance with this invention, the bus loop comprising an RJ45 CAT5/5e/6 twisted pair cable 20 with one and or more RJ45 CAT5/5e/6 twisted pair cables 22 forming a link aggregation to support increase bandwidth and link redundancy, connecting to a power supply extension unit 12, supplying power to a chain ofjunction boxes 13 using the said RJ45 CAT5/5e/6 twisted pair cables 20 with one and or more RJ45 CAT5/5e/6 twisted pair cables 22 forming a link aggregation to support increase bandwidth and link redundancy, repeated again and again using the said power supply extension units 12 and junction boxes 13. Network terminals, devices, clients and or servers 14 are connected to the said power supply extension units 12 and junction boxes 13 using the said RJ45 CAT5/5e/6 twisted pair cables 21.

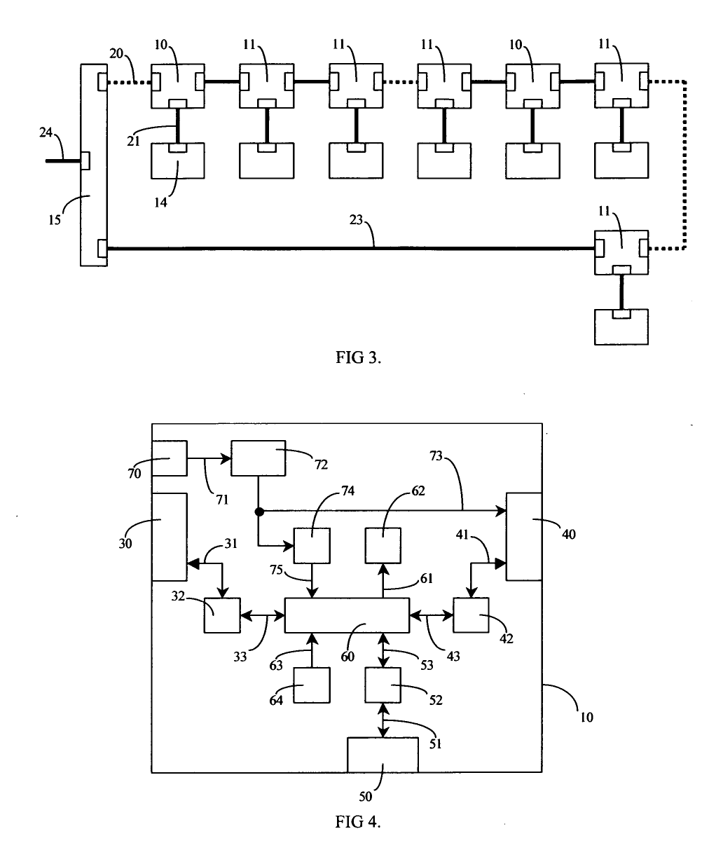

Referring to FIG. 3, there is illustrated therein an alternative form of bus looping with loop back connection topology in accordance with this invention, the bus looping comprising an RJ45 CAT5/5e/6 twisted pair cable 20, connecting to a power supply extension unit 10, supplying power to a chain of junction boxes 11 using the said RJ45 CAT5/5e/6 twisted pair cables 20, repeated again and again using the said power supply extension units 10 and chains of junction boxes 11, and finally looping back to the main switch 15 using an RJ45 CAT5/5e/6 twisted pair cable 23. Network terminals, devices, clients and or servers 14 are connected to the said power supply extension units 10 and junction boxes 11 using the said RJ45 CAT5/5e/6 twisted pair cables 21.

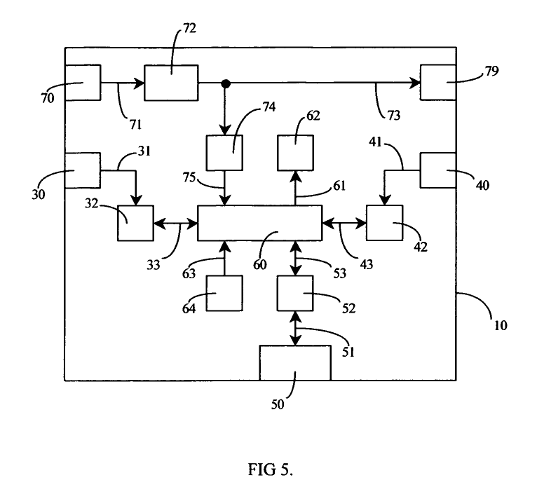

FIG. 4 illustrates a general form of power supply extension unit 10 of FIG. 1 and FIG. 3 in more detailed. Mains power is connected to mains terminal 70, the mains voltage supply line 71 is directed to an AC to DC converter power supply 72 to produce a regulated DC power supply line 73, the said regulated DC power supply line 73 is directed to an RJ45 CAT5/5e/6 terminal 40 and a DC to DC converter power supply 74 to produce a regulated system power supply 75 to power the switch controller 60 and its associated electronics. And EEPROM or a microcontroller 64 is used to configure the internal registers of the said switch controller 60 via a serial or parallel interface 63. Unused ports of the said switch controller 60 are disabled and or powered down.

Physical transceiver pair lines 33, 43 and 53 of the said switch controller 60, are connected to the appropriate standard Ethernet isolation transformers 32, 42 and 52. RJ45 terminal 30 is used as input port; RJ45 terminal 40 is used as output port with regulated DC power supply line 73; RJ45 terminal 50 is used as a standard Ethernet port. The said switch controller 60 is capable of 10 Mbps, 100 bps, half duplex, full duplex, automatic link negotiation and automatic cable crossover correction. The said switch controller 60 has a link status indicator 62 indicating linked speed of 10 Mbps, 100 Mbps, half duplex, full duplex, collision, transmit activity and receive activity. The said status indicator 62 is connected to the said switch controller 60 via a serial or parallel interface 61.

FIG. 5 illustrates an alternative form of power supply extension unit 10 of FIG. 1 and FIG. 3 in more detailed. Mains power is connected to mains terminal 70, the mains voltage supply line 71 is directed to the AC to DC converter power supply 72 to produce a regulated DC power supply line 73, the said regulated DC power supply line 73 is directed to a terminal 79 and a DC to DC converter power supply 74 to produce a regulated system power supply 75 to power the switch controller 60 and its associated electronics. An EEPROM or a microcontroller 64 is used to configure the internal registers of the said switch controller 60 via a serial or parallel interface 63. Unused ports of the said switch controller 60 are disabled and or powered down. Physical transceiver pair lines 33, 43 and 53 of the said switch controller 60, are connected to the appropriate standard Ethernet isolation transformers 32, 42 and 52. RJ45 terminal 50 is used as input port; RJ45 terminal 40 is used as output port; RJ45 terminal 50 is used as a standard Ethernet port. The said switch controller 60 is capable of 10 Mbps, 100 Mbps, 1000 Mbps, half duplex, full duplex, automatic link negotiation and automatic cable crossover correction. The said switch controller 60 has a link status indicator 62 indicating linked speed of 10 Mbps, 100 Mbps, 1000 Mbps, half duplex, full duplex, collision, transmit activity and receive activity. The said status indicator 62 is connected to the said switch controller 60 via a serial or parallel interface 61.

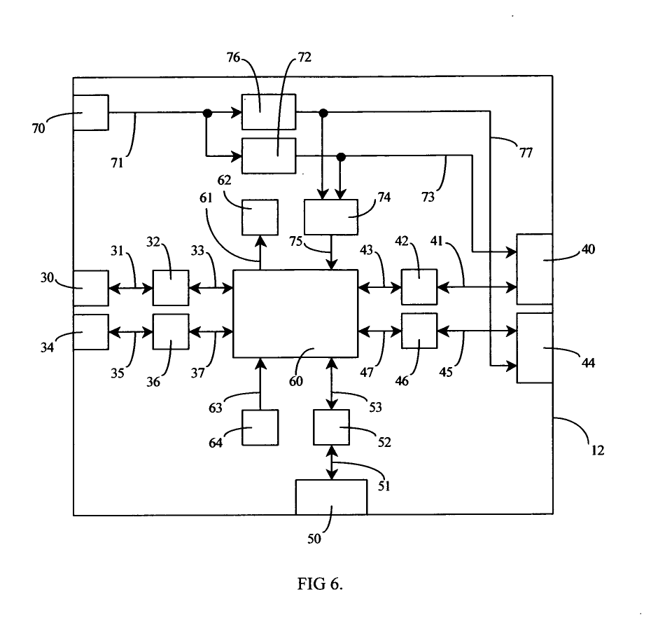

FIG. 6 illustrates a general form of power supply extension unit with link aggregation 12 of FIG. 2 in more detailed. Mains power is connected to mains terminal 70, the mains voltage supply line 71 is directed to two AC to DC converter power supply 72 and 76 to produce two regulated DC power supply line 73 and 77, the said regulated DC power supply line 73 is directed to an RJ45 terminal 40 and the said regulated DC power supply line 77 is directed to an RJ45 terminal 44. The two regulated power supply lines 73 and 77 are used in DC to DC converter power supply 74 to produce a regulated system power supply 75 to power the switch controller 60 and its associated electronics. And EEPROM or a microcontroller 64 is used to configure the internal registers of the said switch controller 60 via a serial or parallel interface 63. Unused ports of the said switch controller 60 are disabled and or powered down. Physical transceiver pair lines 33, 37, 43, 47 and 53 of the said switch controller 60, are connected to the appropriate standard Ethernet isolation transformers 32, 36, 42, 46 and 52. RJ45 terminal 30 and 34 used as input ports; RJ45 terminal 40 and 44 is used as output ports with regulated DC power supply lines 73 and 77; RJ45 terminal 50 is used as a standard Ethernet port. The said switch controller 60 is capable of 10 Mbps, 100 Mbps, half duplex, full duplex, automatic link negotiation and automatic cable crossover correction. The said switch controller 60 has a link status indicator 62 indicating link speed of 10 Mbps, 100 Mbps, half duplex, full duplex, collision, transmit activity and receive activity. The said status indicator 62 is connected to the said switch controller 60 via a serial or parallel interface 61.

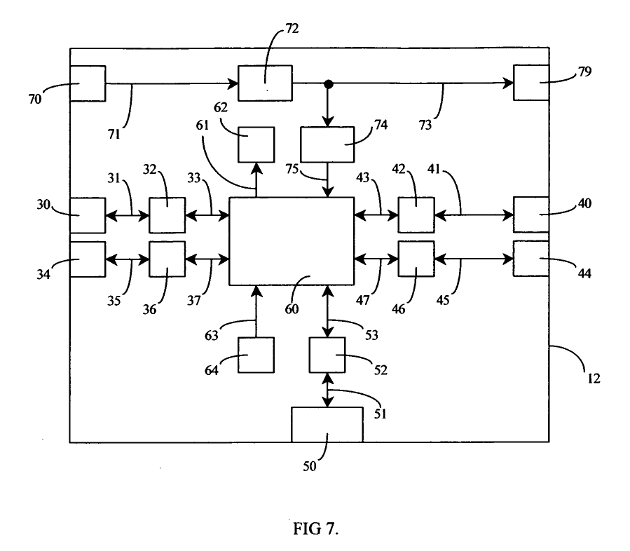

FIG. 7 illustrates an alternative form of power supply extension unit with link aggregation 12 of FIG. 2 in more detailed. Mains power is connected to mains terminal 70, the mains voltage supply line 71 is directed to an AC to DC converter power supply 72 to produce a regulated DC power supply line 73, the said regulated DC power supply line 73 is directed to terminal 79 and a DC to DC converter power supply 74 to produce a regulated system power supply 75 to power the switch controller 60 and its associated electronics. An EEPROM or a microcontroller 64 is used to configure the internal registers of the said switch controller 60 via a serial or parallel interface 63. Unused ports of the said switch controller 60 are disabled and or powered down. Physical transceiver pair lines 33, 37. 43, 47 and 53 of the said switch controller 60, are connected to the appropriate standard Ethernet isolation transformers 32, 36, 42, 46 and 52. RJ45 terminal 30 and 34 are used as input ports; RJ45 terminal 40 and 44 is used as output; RJ45 terminal 50 is used as a standard Ethernet port. The said switch controller 60 is capable of 10 Mbps, 100 Mbps, 1000 Mbps, half duplex, full duplex, automatic link negotiation and automatic cable crossover correction. The said switch controller 60 has a link status indicator 62 indicating link speed of 10 Mbps, 100 Mbps, 1000 Mbps, half duplex, full duplex, collision, transmit activity and receive activity. The said status indicator 62 is connected to the said switch controller 60 via a serial or parallel interface 61.

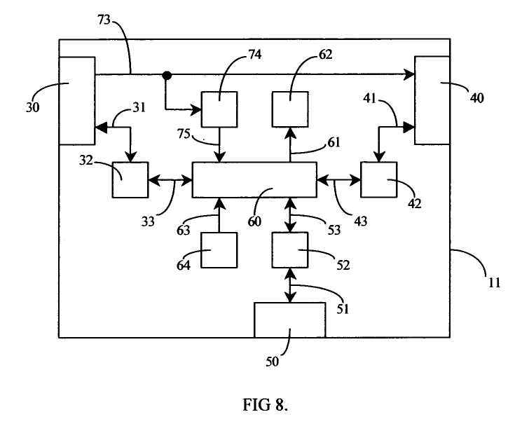

FIG. 8 illustrates a general form of junction box 11 of FIG. 1 and FIG. 3 in more detailed. RJ45 CAT5/5e/6 terminal 30 carries both DC regulated power line 73 and network signals 31. The said regulated DC power supply line 73 is directed to an RJ45 CAT5/5e/6 terminal 40 and a DC to DC power converter power supply 74 to produce a regulated system power supply 75 to power the switch controller 60 and its associated electronics. And EEPROM or a microcontroller 64 is used to configure the internal registers of the said switch controller via a serial or parallel interface 63. Unused ports of the said switch controllers are disabled and or powered down. Physical transceiver pair lines 33, 43, and 53 of the said switch controller 60, are connected to the appropriate standard Ethernet isolation transformers 32, 42 and 52. RJ45 CAT5/5e/6 terminal 30 is used as input port; RJ45 CAT5/5e/6 terminal 40 is used as output port; RJ45 CAT5/5e/6 terminal is used as a standard Ethernet port. The regulated DC power supply line 73 connects both RJ45 CAT5/5e/6 terminals 30 and 40. The said switch controller 60 is capable of 10 Mbps, 100 Mbps, half duplex, full duplex, automatic link negotiation and automatic cable crossover correction. The said switch controller 60 has a link status indicator 62 indicating link speed of 10 Mbps, 100 Mbps, half duplex, full duplex, collision, transmit activity and receive activity. The said status indicator 62 is connected to the said switch controller 60 via a serial or parallel interface 61.

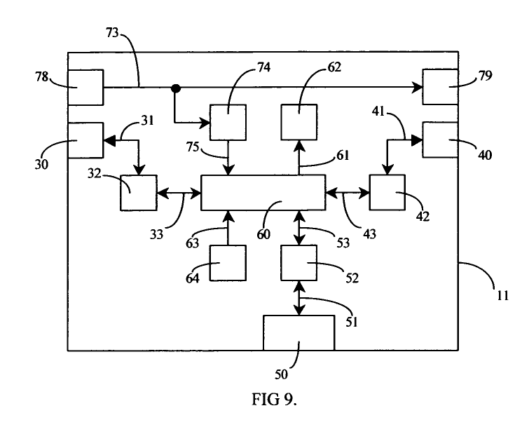

FIG. 9 illustrates an alternative form of junction box 11 of FIG. 1 and FIG. 3 in more detailed. Terminal 78 carries the DC regulated power line 73 while RJ45 CAT5/5e/6 terminal 30 carries the network signals 31. The said DC regulated power supply line 73 is directed to terminal 79 and a DC to DC converter power supply 74 to produce a regulated system power supply 75 to power the switch controller 60 and its associated electronics. An EEPROM or a microcontroller 64 is used to configure the internal registers of the said switch controller via a serial or parallel interface 63. Unused ports of the said switch controllers are disabled and or powered down. Physical transceiver pair lines 33, 43 and 53 of the said switch controller 60, are connected to the appropriate standard Ethernet isolation transformers 32, 42 and 52. RJ45 CAT5/5e/6 terminal 30 is used as input port; RJ45 CAT5/5e/6 terminal 40 is used as output port; RJ45 CAT5/5e/6 terminal is used as a standard Ethernet port. The regulated DC power supply line 73 connects both terminals 78 and 79. The said switch controller 60 is capable of 10 Mbps, 100 Mbps, 1000 Mbps. half duplex, full duplex, automatic link negotiation and automatic cable crossover correction. The said switch controller 60 has a link status indicator 62 indication link speed 10 Mbps, 100 Mbps, 1000 Mbps, half duplex, full duplex, collision, transmit activity and receive activity. The said status indicator 62 is connected to the said switch controller 60 via a serial or parallel interface 61.

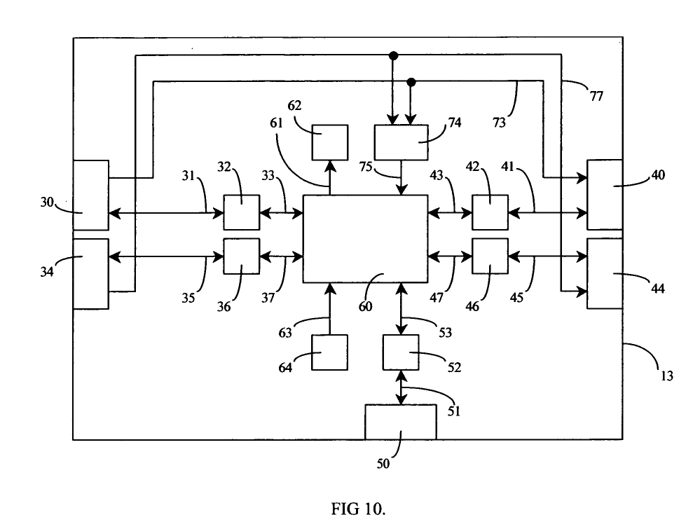

FIG. 10 illustrates a general form of junction box with link aggregation 13 of FIG. 2 in more detailed. Both RJ45 CAT5/5e/6 terminal 30 and 34 carries both DC regulated power line 73 and 77 network signals 31 and 35. The said DC regulated power supply line 73 and 77 is directed to an RJ45 CAT5/5e/6 terminal 40 and 44. The two regulated DC power supply lines 73 and 77 are used in DC to DC converter power supply 74 to produce a regulated system power supply 75 to power the switch controller 60 and its associated electronics. And EEPROM or a microcontroller 64 is used to configure the internal registers of the said switch controller 60 via a serial or parallel interface 63. Unused ports of the said switch controller 60 are disabled and or powered down. Physical transceiver pair lines 33, 37, 43, 47 and 53 of the said switch controller 60, are connected to the appropriate standard Ethernet isolation transformers 32, 36, 42, 46 and 52. RJ45 terminal 30 and 34 are used as input ports; RJ45 terminal 40 and 44 is used as output ports with regulated DC power supply lines 73 and 77; RJ45 terminal 50 is used as a standard Ethernet port. The said switch controller 60 is capable of 10 Mbps, 100 Mbps, half duplex, full duplex, automatic link negotiation and automatic cable crossover correction. The said switch controller 60 has a link status indicator 62 indicating link speed of 10 Mbps, 100 Mbps, half duplex, full duplex, collision, transmit activity and receive activity. The said status indicator 62 is connected to the said switch controller 60 via a serial or parallel interface 61.

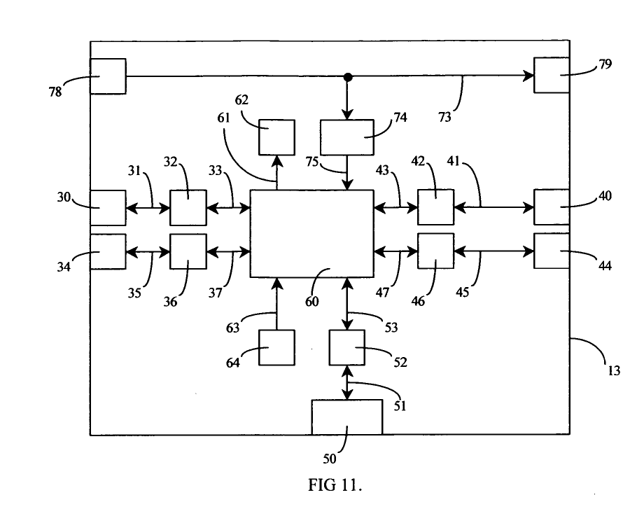

FIG. 11 illustrates an alternative form ofjunction box with link aggregation 13 of FIG. 2 in more detailed. Terminal 78 carries the DC regulated power line 73 while CAT5/5e/6 terminal 30 and 34 carries the network signal 31 and 35. The said DC regulated power supply line 73 is directed to terminal 79 and a DC to DC converter power supply 74 to produce a regulated system power supply 75 to power the switch controller 60 and its associated electronics. An EEPROM or a microcontroller 64 is used to configure the internal registers of the said switch controller 60 via a serial or parallel interface 63. Unused ports of the said switch controller 60 are disabled and or powered down. Physical transceiver pair lines 33, 37, 43, 47 and 53 of the said switch controller 60, are connected to the appropriate standard Ethernet isolation transformers 32, 36, 42, 46 and 52. RJ45 terminal 30 and 34 are used as input ports; RJ 45 terminal 40 and 44 is used as output; RJ45 terminal 50 is used as a standard Ethernet port. The said switch controller 60 is capable of 10 Mbps, 100 Mbps, 1000 Mbps, half duplex, full duplex, automatic link negotiation and automatic cable crossover correction. The said switch controller 60 has a link status indicator 62 indicating link speed 10 Mbps, 100 Mbps, 1000 Mbps, half duplex, full duplex, collision, transmit activity and receive activity. The said status indicator 62 is connected to the said switch controller 60 via a serial or parallel interface 61.

Numerous other modifications, variations and adaptations may be made to the particular embodiments of the invention described above without departing from the scope of the invention as defined in the claims.

1. The network connection in an Ethernet environment components comprising;
one or plurality of power supply extensions, one or plurality of junction boxes,
one or plurality of clients or servers;
a power supply extensions components having one or plurality of input and output terminals;
a junction box components having one or plurality of input and output terminal;
a bus looping connection topology connecting each network components repeatedly with network cables.

2. The main switch comprising:
an optional one and or plurality of uplink ports, output ports; and loop back input ports;
a switch controller capable of 10 Mbps, 100 Mbps, 1000 Mbps, half-duplex, full-duplex, automatic link negotiations and automatic cable crossover corrections;
a switch controller wherein all unused ports are disabled and or powered down;
an EEPROM and or microcontroller is used to program and configure the switch controller via a serial or parallel interface;
all output ports and loop back input ports are connected to the switch controller physical transceivers via isolation transformers; an optional one and or plurality of uplink ports are connected to the switch controller physical transceivers via isolation transformers;
link status indicator indicating linked speed of 10 Mbps, 100 Mbps, 1000 Mbps, half-duplex, full-duplex, collision, transmit activity and receive activity for all ports.

3. A bus looping connection topology comprising a main switch wherein the said output port of the main switch is connected in a bus looping topology as claimed in claim 1 wherein the last output port of the said junction box is connected back to the loop back input port of the said main switch thereby creating a link redundancy.

4. The power supply extension unit comprising:
a mains input terminal, an input port and an output port;
an AC to DC converter to convert the mains voltage to a regulated DC power supply supplying power to the output port;
a DC to DC converter to convert the regulated DC power supply to a regulated low voltage system power supply to power the switch controller and its associated electronics;
a switch controller as in claim 2.

5. The power supply extension unit as in claim 4; wherein an optional regulated DC power supply is provided to an additional output terminal.

6. The power supply extension unit as in claim 4;
further comprising a plurality of input ports and output ports are grouped together as one link-aggregated port supporting high bandwidth and redundancy; and
an AC to DC converter to convert the mains voltage to an additional regulated DC power supplies supplying power to provide to output ports thereby creating a power supply redundancy.

7. The power supply extension unit as in claim 6; wherein an AC to DC converter to convert the mains voltage to regulated DC power supply supplying power to the output power terminal.

8. The junction box unit comprising:
an input port, an output port; and one and or plurality of common ports;
a regulated DC power supply from a power supply extension unit output port as claimed in claim 4 wherein which is connected to the said input port and output port of the said junction box;
a DC to DC converter to convert the regulated DC power supply to a regulated low voltage system power supply to power the switch controller and its associated electronics; and
a switch controller.

9. The junction box as in claim 8, wherein added regulated DC power supply from the said output terminal, wherein additional input power terminal and output power terminal, the added DC power supply is to sustain sufficient power supply to any extended components in the said bus looping connection topology.

10. The junction box unit as in claim 8; wherein a plurality of input ports, a plurality output ports; and one and or plurality of common ports; all these plurality of input and output ports are grouped together as one link-aggregated port supporting high bandwidth and redundancy; a regulated DC power supply from said power supply extension unit output ports;
wherein is connected to the said input ports and output ports of the said junction box; a bus looping with link aggregation connection topology is made repeatedly as.

11. The junction box unit as in claim 10; wherein a regulated DC power supply from the power supply extension unit output port; wherein is connected to the input terminal of the junction box to the output terminals of junction box, a bus looping with link aggregation connection topology is made repeatedly.
